(19) United States
(12) Patent Application Publication
(10) Pub. No.: US 2017/0167545 A1
(43) Pub. Date: Jun. 15, 2017

(54) CLUTCH SYSTEM FOR A VEHICLE POWERTRAIN

(71) Applicant: FORD GLOBAL TECHNOLOGIES, LLC, Dearborn, MI (US)

(72) Inventors: Dengfu ZHANG, Northville, MI (US); Jau-Wen TSENG, Ann Arbor, MI (US); Chin-Yuan PERNG, Ann Arbor, MI (US)

(21) Appl. No.: 14/966,703

(22) Filed: Dec. 11, 2015

(51) Int. Cl. F16D 13/52; F16D 25/0638; F16D 13/74

(52) U.S. Cl. CPC F16D 13/52; F16D 13/74; F16D 25/0638

(57) ABSTRACT

A clutch pack includes a first set of clutch plates and a second set of clutch plates. The first set of clutch plates are arranged in an alternating configuration with the second set of clutch plates. The first set of clutch plates has radially outward extending teeth. The second set of clutch plates has radially inward extending teeth that define channels that are configured to allow air to flow into the clutch pack in an axial direction such that lubrication fluid located between adjacent clutch plates is channeled radially outward.

### TECHNICAL FIELD

The present disclosure relates to clutches utilized to couple various rotating elements in a vehicle powertrain system.

### BACKGROUND

A transmission in a vehicle may be shifted between multiple gears by engaging and disengaging friction plates and separator plates in a clutch pack. Drag torque caused by lubrication fluid located between adjacent plates when the clutch is in an open state may significantly affect fuel economy.

### SUMMARY

A vehicle includes a transmission. The transmission includes first and second splined shafts. The first shaft has splines that extend radially outward. The second shaft defines a splined orifice. A clutch pack is disposed within the splined orifice between the first and second splined shafts. The clutch pack has a first plurality of clutch plates that have radially inward extending teeth that engage valleys defined between adjacent splines of the first shaft. The clutch pack also has a second plurality of clutch plates that have radially outward extending teeth that engage the splined orifice defined by the second shaft. The individual clutch plates of the first and second pluralities of clutch plates are arranged in an alternating configuration. At least a portion of the inwardly extending teeth define passages that are configured to channel air into the clutch pack in an axial direction relative to the clutch pack in order to channel lubrication fluid located between adjacent clutch plates out of the clutch pack in a radial direction.

A transmission includes a first shaft, a second shaft, and a plurality of clutch plates. The first shaft has splines that extend radially outward. The second shaft defines a splined socket. The clutch plates are disposed within the splined socket. A first configuration of the clutch plates have teeth that extend inwardly from inner diameters of the clutch plates. The inwardly extending teeth engage valleys defined between adjacent splines of the first shaft. A second configuration of the clutch plates have teeth that extend outwardly from outer diameters of the clutch plates. The outwardly extending teeth engage the splined socket of the second shaft. Individual clutch plates of the first and second configurations are arranged in an alternating pattern. At least a portion of the inwardly extending teeth define passages that are configured to channel air into the splined socket in an axial direction relative to the first and second shafts in order to channel lubrication fluid located between adjacent clutch plates out of the clutch pack in a radial direction relative to the first and second shafts.

A clutch pack includes a first set of clutch plates and a second set of clutch plates. The first set of clutch plates are arranged in an alternating configuration with the second set of clutch plates. The first set of clutch plates has radially outward extending teeth. The second set of clutch plates has radially inward extending teeth that define channels that are configured to allow air to flow into the clutch pack in an axial direction such that lubrication fluid located between adjacent clutch plates is channeled radially outward.

### BRIEF DESCRIPTION OF THE DRAWINGS

FIG. 1 is a schematic diagram illustrating an exemplary vehicle and an exemplary vehicle powertrain;

FIG. 2 is an illustration of two rotating elements that are selectively coupled together by a shift element;

FIG. 3 is a cross section taken along line 3-3 in FIG. 2; and

FIG. 4 is a cross-section taken along line 4-4 in FIG. 3.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A group of rotating elements are fixedly coupled to one another if they are constrained to rotate at the same speed about the same axis in all operating conditions. Rotating elements can be fixedly coupled by spline connections, welding, press fitting, machining from a common solid, or other means. Slight variations in rotational displacement between fixedly coupled elements can occur such as displacement due to lash or shaft compliance. One or more rotating elements that are all fixedly coupled to one another may be called a shaft. In contrast, two rotating elements are selectively coupled by a shift element when the shift element constrains them to rotate at the same speed about the same axis whenever it is fully engaged and they have different rotational speeds about that axis in at least some other operating condition. A shift element that holds a rotating element against rotation by selectively coupling it to a fixed housing is called a brake. A shift element that selectively couples two or more rotatable elements to one another is called a clutch. Shift elements may be actively controlled devices such as hydraulically or electrically actuated clutches or brakes or may be passive devices such as one way clutches or brakes. Shift elements may be positive engagement devices such as dog clutches or friction devices capable of transmitting torque between elements in the presence of relative rotation. Two elements are coupled if they are either fixedly coupled or selectively coupled.

A gearing arrangement is a collection of gearing elements and shift elements configured to impose specified speed relationships among a set of shafts. A speed relationship is fixedly imposed by a gearing arrangement if it is imposed regardless of the state of any shift elements. A speed relationship is selectively imposed by a gearing arrangement if the speed relationship is imposed only when particular shift elements of the gearing arrangement are fully engaged. The speed of a shaft is positive when the shaft rotates in one direction and negative when the shaft rotates in the opposite direction. A proportional speed relationship exists between a first shaft and a second shaft when the ratio of their speeds is constrained to be a predetermined value. A proportional speed relationship between a first shaft and a second shaft is an underdrive relationship if the ratio of the second shaft speed to the first shaft speed is between zero and one. Similarly, a proportional speed relationship between a first shaft and a second shaft is an overdrive relationship if the ratio of the second shaft speed to the first shaft speed is greater than one. A linear speed relationship exists among an ordered list of shafts when i) the first and last shaft in the ordered list are constrained to have the most extreme speeds, ii) the speeds of the remaining shafts are each constrained to be a weighted average of the speeds of the first and last shafts with predetermined weightings, and iii) when the speeds of the shafts differ, they are constrained to be in the listed order, either increasing or decreasing.

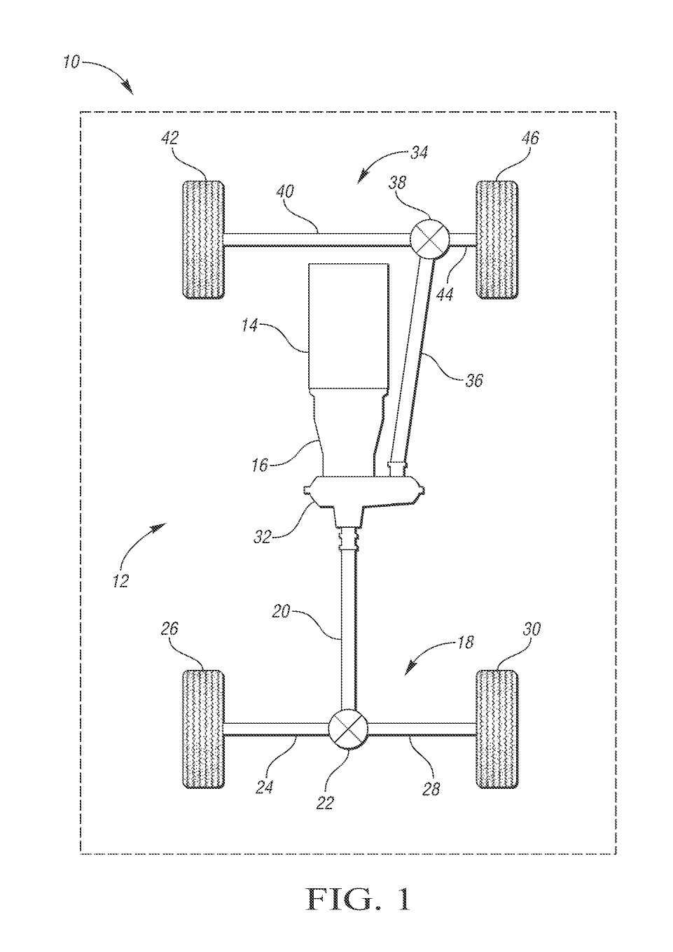

Referring to FIG. 1, an exemplary vehicle 10 and an exemplary powertrain 12 of the vehicle 10 are illustrated. The powertrain 12 may include at least one power source (power generating device) 14. The power source 14 may be an internal combustion engine, electric machine (electric motor), or any other device capable of generating motive power in the powertrain 12. The power source 14 may be connected to an input of a transmission 16. The transmission 16 may be a manual transmission, or a multiple step-ratio automatic transmission. The transmission may include a plurality of gearing arrangements that are capable of adjusting the gear ratio between the input and an output of the transmission 16 upon activation of various shifting elements. The vehicle 10 may include a first axle 18. The first axle 18 may be connected to the output of the transmission 16 via a first driveshaft 20.

The first driveshaft 20 may be connected to a first differential 22 located on the first axle 18. The first driveshaft 20 may also be referred to as an input to the first differential 22. A first half shaft 24 of the first axle 18 may connect the first differential 22 to a first wheel 26 of the first axle 18. A second half shaft 28 of the first axle 18 may connect the first differential 22 to a second wheel 30 of the first axle 18. The first half shaft 24 and the second half shaft 28 of the first axle 18 may also be referred to as outputs of the first differential 22. The first differential 22 is configured to allow the first half shaft 24 and second half shaft 28 to rotate at different speeds, thereby allowing the first wheel 26 and second wheel 30 rotate at different speeds. In this configuration, power generated by the power source 14 may be transferred to the first wheel 26 and second wheel 30 of the first axle 18 via the transmission 16, first driveshaft 20, first differential 22, first half shaft 24 and second half shaft 28.

The powertrain 12 may also include a transfer case 32 connected to the output of the transmission 16. The transfer case 32 may be configured to selectively transfer power between the first axle 18 and a second axle 34. The transfer case 32 may include several selectable power transferring modes. The power transferring modes may include transferring power to only one of the first axle 18 or second axle 34, simultaneously transferring power to the first axle 18 and second axle 34, or a neutral mode where no power is transferred to either the first axle 18 or second axle 34.

The transfer case 32 may be disposed between the transmission 16 and the first driveshaft 20. A second driveshaft 36 may connect the second axle 34 to the transfer case 32. The transmission 16 may be referred to as the input to the transfer case 32 while the first driveshaft 20 and second driveshaft 36 may be referred to as outputs of the transfer case 32.

The second driveshaft 36 may be connected to a second differential 38 located on the second axle 34. The second driveshaft 36 may also be referred to as an input to the second differential 38. A first half shaft 40 of the second axle 34 may connect the second differential 38 to a first wheel 42 of the second axle 34. A second half shaft 44 of the second axle 34 may connect the second differential 38 to a second wheel 46 of the second axle 34. The first half shaft 40 and second half shaft 44 of the second axle 34 may also be referred to as outputs of the second differential 38. The second differential 38 is configured to allow the first half shaft 40 and second half shaft 44 to rotate at different speeds, thereby allowing the first wheel 42 and second wheel 46 two rotate at different speeds. In this configuration, power generated by the power source 14 may be transferred to the first wheel 26 and second wheel 30 of the first axle 18 via the transmission 16, transfer case 32, first driveshaft 20, first differential 22, first half shaft 24 and second half shaft 28. Power generated by the power source 14 may also be transferred to the first wheel 42 and second wheel 46 of the second axle 34 via the transmission 16, transfer case 32, second driveshaft 36, second differential 38, first half shaft 40, and second half shaft 44.

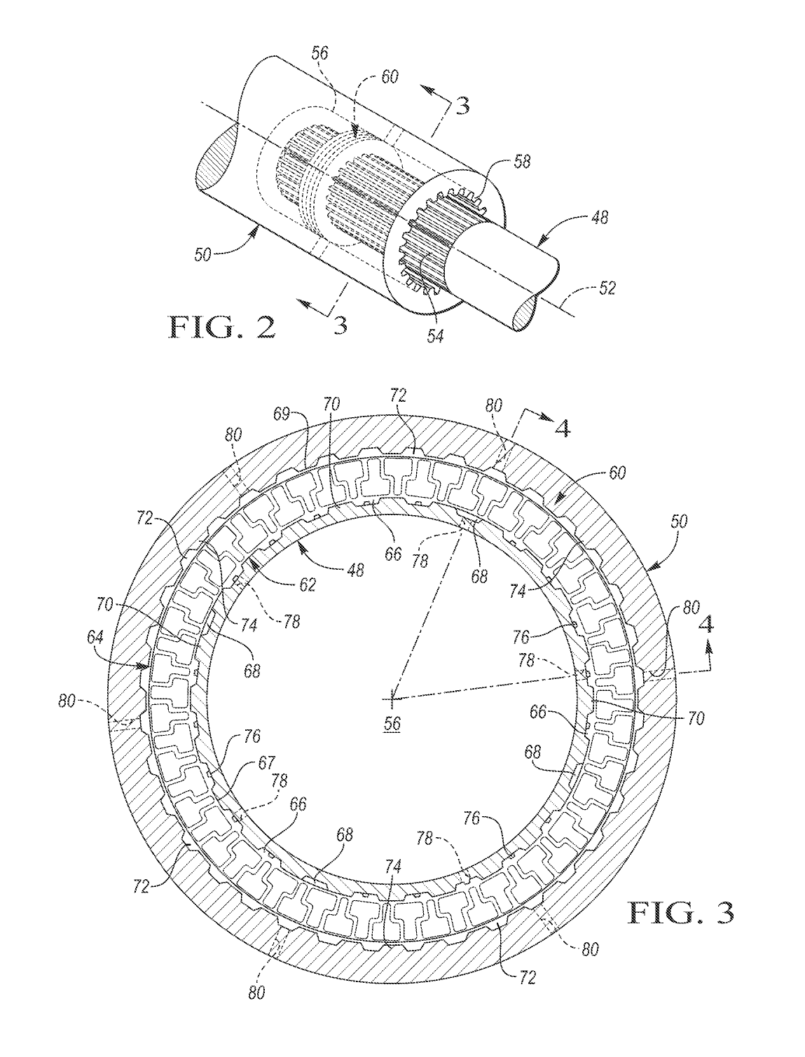

Referring to FIG. 2, two rotating elements that are selectively coupled together by a shift element or clutch are illustrated. The two rotating elements and shift element may be one of the pluralities of gearing arrangements found within the transmission 16. Alternatively, the rotating elements and shift element may be a gearing arrangement that is part of the transfer case 32 or any other vehicle component that may require selectively coupling two rotating elements together with a shift element.

The rotating elements may include a first splined shaft 48 and a second splined shaft 50. The first splined shaft 48 and the second splined shaft 50 may extend in an axial direction along a longitudinal axis 52. The first splined shaft 48 may include a first set of splines 54 that extend radially outward relative to the longitudinal axis 52. The second splined shaft 50 may define a splined orifice 56. The second splined shaft 50 may include a second set of splines 58 that extend radially inward relative to the longitudinal axis 52 and into the splined orifice 56. The first splined shaft 48 may be referred to as a clutch hub while the second spline shaft 50 may be a clutch house. A portion of the first splined shaft 48 may be disposed within the splined orifice 56 of the second splined shaft 50. A clutch pack 60 may be disposed within the splined orifice 56 between the first splined shaft 48 and the second splined shaft 50. The clutch pack 60 may be configured to selectively couple the first splined shaft 48 to the second splined shaft 50. The clutch pack 60 may include a plurality of clutch plates. A first portion of the plates are fixedly secured to the first splined shaft 48 while a second portion clutch plates that are fixedly secured to the second splined shaft 50. The clutch plates that are fixedly secured to the first splined shaft 48 may not also be fixedly secured to the second spline shaft 50. The clutch plates that are fixedly secured to the second splined shaft 50 may not also be fixedly secured to the first spline shaft 48. The two types of clutch plates, that are either fixedly secured to the first splined shaft 48 or the second splined shaft 50, may be referred to as friction plates and separator plates. The friction plates and separator plates may be arranged in an alternating configuration such that individual friction plates are separated by separator plates and individual separator plates are separated by friction plates.

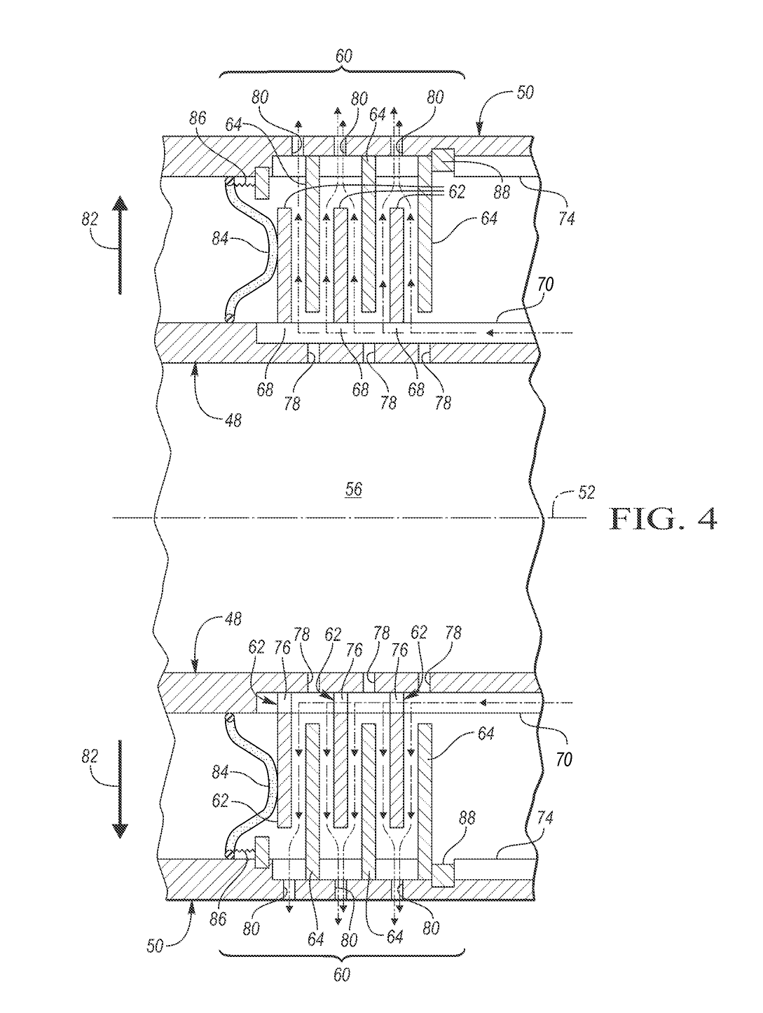

Referring to FIGS. 3 and 4, the first splined shaft 48, second splined shaft 50, and clutch pack 60 are illustrated. FIG. 3 includes a front view of the clutch pack 60 and cross-sections of the first and second splined shafts 48, 50. FIG. 4 includes cross-sections of the first splined shaft 48, second splined shaft 50, and clutch pack 60. The clutch pack 60 includes a first set of clutch plates 62 that are fixedly secured to the first splined shaft 48. The first set of clutch plates 62 may be referred to as friction plates. The friction plates may be composed of a core metal plate with a friction layer on top of the metal plate. The friction plates may include grooves on the friction layer. The clutch pack 60 also includes a second set of clutch plates 64 that are fixedly secured to the second splined shaft 50. The second set of clutch plates 64 may be referred to as separator plates. Alternatively, the first set of clutch plates 62 may be referred to as separator plates while the second set of clutch plates 64 may be referred to as friction plates.

The first set of clutch plates 62 may have radially inward extending teeth 66. The radially inward extending teeth 66 may extend from inner circumferences or inner diameters 67 of the first set of clutch plates 62 and may engage valleys 68 that are defined between adjacent outwardly extending splines 70 of the first splined shaft 48. The second set of clutch plates 64 may have radially outward extending teeth 72. The radially outward extending teeth 72 may extend from outer circumferences or outer diameters 69 of the second set of clutch plates 64 and may engage the splined orifice 56 defined by the second splined shaft 50. Specifically the radially outward extending teeth 72 may engage valleys defined between adjacent inwardly extending splines 74 of the second splined shaft 50.

Venting features may be added to clutch plates of a clutch pack to create an air flow passage in an axial direction relative to the clutch plates and the adjoining rotating shafts to enable external air to reach the inner regions of the clutch plates. The venting features may be added to the inner radius of the clutch plates to allow air to be drawn into the spaces between adjacent clutches in order to remove the lubrication fluid located between the adjacent clutch plates.

At least a portion of radially inward extending teeth 66 of the first set of clutch plates 62 may define passages that are configured to channel air into the clutch pack 60. At least a portion of the passages that are configured to channel air into the clutch pack 60 may consist of notches or grooves 76 that are defined along the ends of the radially inward extending teeth 66. Another portion of the passages that that are configured to channel air into the clutch pack 60 may consist of the valleys 68 defined between the adjacent outwardly extending splines 70 of the first splined shaft 48 corresponding to the absence mating radially inward extending teeth 66 in the first set of clutch plates 62. If two or more of the passages that are configure to channel air into the clutch pack 60 consist of the valleys 68 corresponding to an absence of mating radially inwardly extending teeth 66 in the first set of clutch plates 62, the passages may be evenly spaced radially along the first splined shaft 48.

The first splined shaft 48 may include a first set of radially extending channels 78 that are in fluid communication with the clutch pack 60. The first set of radially extending channels 78 may be configured to channel lubrication fluid into the clutch pack 60. The second splined shaft 50 may include a second set of radially extending channels 80 that are in fluid communication with the clutch pack 60. The second set of radially extending channels 80 may be configured to channel lubrication fluid out of the clutch pack 60.

The passages that may consist of the valleys 68 and the grooves 76 may be configured to channel air into the clutch pack in axial direction (or along the longitudinal directionof the longitudinal axis 52) relative to the first splined shaft 48, second splined shaft 50, and clutch pack 60. Once air is channeled into clutch pack, it may be re-routed to flow in a radial direction 82 relative to the first splined shaft 48, second splined shaft 50, and clutch pack 60 to force any lubrication fluid that is located between adjacent clutch plates 62, 64 out of the clutch pack 60 and through the second set of radially extending channels 80. The air flow into and through the clutch pack and the lubrication flow out of the clutch pack are both indicated by the arrows that first flow into the clutch pack in the axial direction and then between the adjacent clutch plates 62, 64 in the radial direction.

The clutch pack 60 may also include a hydraulically operated piston 84 that is configured to force adjacent clutch plates 62, 64 into contact with each other in order to couple the first shaft 48 to the second shaft 50. A return mechanism 86, such as a biasing element or spring, may be configured to disengage the piston 84 when it is desirable to decouple the first splined shaft 48 from second splined shaft 50. A retention mechanism 88, such as a retainer ring, may be disposed opposite of the piston, to limit the travel of the clutch plates 62, 64.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a transmission having first and second splined shafts, the first shaft having splines extending radially outward and the second shaft defining a splined orifice; and
a clutch pack disposed within the splined orifice between the first and second splined shafts, the clutch pack having a first plurality of clutch plates having radially inward extending teeth that engage valleys defined between adjacent splines of the first shaft and a second plurality of clutch plates having radially outward extending teeth that engage the splined orifice defined by the second shaft, wherein individual clutch plates of the first and second pluralities of clutch plates are arranged in an alternating configuration and at least a portion of the inwardly extending teeth define passages configured to channel air into the clutch pack in an axial direction relative to the clutch pack in order to channel lubrication fluid located between adjacent clutch plates out of the clutch pack in a radial direction relative to the clutch pack.

2. The vehicle of claim 1, wherein the first splined shaft defines a first set of radially extending channels that are in fluid communication with the clutch pack and are configured to channel lubrication fluid into the clutch pack.

3. The vehicle of claim 2, wherein the second splined shaft defines a second set of radially extending channels that are in fluid communication with the clutch pack and are configured to channel lubrication fluid out of the clutch pack.

4. The vehicle of claim 3, wherein the passages are grooves that are defined along ends of the inwardly extending teeth.

5. The vehicle of claim 3, wherein at least one of the passages comprises at least one of the valleys defined between the adjacent splines in the first shaft corresponding to an absence of mating inwardly extending teeth in the first plurality of clutch plates.

6. The vehicle of claim 3, wherein at least two of the passages comprise at least two or more evenly spaced valleys defined between the adjacent splines in the first shaft corresponding to the absence of mating inwardly extending teeth in the first of the plurality of clutch plates.

7. The vehicle of claim 1, wherein a portion of the first splined shaft is disposed within the splined orifice defined by the second shaft.

8. A transmission comprising:
a first shaft having splines extending radially outward;
a second shaft defining a splined socket;
a plurality of clutch plates disposed within the splined socket, the clutch plates having inner and outer diameters, a first configuration of the clutch plates having teeth extending inwardly from the inner diameters and engaging valleys defined between adjacent splines of the first shaft, a second configuration of the clutch plates having teeth extending outwardly from the outer diameters and engaging the splined socket of the second shaft, wherein individual clutch plates of the first and second configurations are arranged in an alternating pattern and at least a portion of the inwardly extending teeth define passages configured to channel air into the splined socket in an axial direction relative to the first and second shafts in order to channel lubrication fluid located between adjacent clutch plates out of the clutch pack in a radial direction relative to the first and second shafts.

9. The transmission of claim 8, wherein the first splined shaft defines a first set of radially extending channels that are in fluid communication with the clutch plates and are configured to channel lubrication fluid into the splined socket.

10. The transmission of claim 9, wherein the second splined shaft defines a second set of radially extending channels that are in fluid communication with the splined socket and are configured to channel lubrication fluid out of the splined socket.

11. The transmission of claim 10, wherein the passages are grooves that are defined along ends of the inwardly extending teeth.

12. The transmission of claim 10, wherein at least one of the passages comprises at least one of the valleys defined between the adjacent splines in the first shaft corresponding to an absence of mating inwardly extending teeth in the first configuration of clutch plates.

13. The transmission of claim 10, wherein at least two of the passages comprise at least two or more evenly spaced valleys defined between the adjacent splines in the first shaft corresponding to the absence of mating inwardly extending teeth in the first configuration of clutch plates.

14. The transmission of claim 8, wherein a portion of the first splined shaft is disposed within the splined orifice defined by the second shaft.

15. A clutch pack comprising:
a first set of clutch plates arranged in an alternating configuration with a second set of clutch plates, the first set having radially outward extending teeth and the second set having radially inward extending teeth that define channels that are configured to allow air to flow into the clutch pack in an axial direction such that lubrication fluid located between adjacent clutch plates is channeled radially outward.

16. The clutch pack of claim 15, wherein a first portion of the channels are grooves that are defined along ends of the inwardly extending teeth.

17. The clutch pack of claim 16, wherein a second portion of the channels are defined by an absence of a least one inwardly extending tooth in the clutch plates.

18. The clutch pack of claim 16, wherein a second portion of the channels are defined by two or more evenly spaced absences of inwardly extending teeth in the clutch plates.
